(19) United States
(12) Patent Application Publication
(10) Pub. No.: US 2006/0007894 A1
(43) Pub. Date: Jan. 12, 2006

(54) Apparatus, program, and method for multiplex transmission

(76) Inventor: Hiroki Igarashi, Toda (JP)

Correspondence Address: SWIDLER BERLIN LLP, 3000 K STREET, NW, BOX IP, WASHINGTON, DC, 20007, US

(21) Appl. No.: 11/011,684

(22) Filed: Dec. 15, 2004

(30) Foreign Application Priority Data
Jul. 12, 2004 (JP) 2004-204481

(51) Int. Cl. H04B 7/216

(52) U.S. Cl. 370/335

(57) ABSTRACT

An information electronic apparatus for receiving a first request information from another information electronic apparatus connected to a network and for sending a response to the first request information, comprises a first storing unit operable to store the first request information, a generating unit operable to generate response information to the first request information, a second storing unit operable to store the generated response information, a comparing unit operable to compare the first request information stored in the first storing unit and a second request information, when the second request information is received, and a transmitting unit operable to retrieve the response information from the second storing unit and transmit the response information to the other information electronic apparatus when the comparing unit determines that the first request information and the second request information match.

### CROSS-REFERENCE TO RELATED APPLICATIONS

This application is related to and claims the benefit of priority to Japanese Patent Application No. 2004-204481, filed Jul. 12, 2004, in Japan, the contents of which are incorporated by reference here in.

### BACKGROUND OF THE INVENTION

1. Field of the Invention

The present invention relates to multiplex transmission in an information electronic apparatus connected to networks.

2. Description of the Related Art

During manipulation of web applications, multiplex transmission happens to occur when the information input with a browser is transmitted to a server, for example, because a double-click is executed by erroneous operation of a user under the condition that only a single click is required or the transmission button is depressed again before execution of the next manipulation.

Japanese Patent Application Laid-Open No. 2001-229103 discloses a method for eliminating multiplex transmission in such a web application.

Method for giving a transmission flag using the facilities in the client side using the Java (registered trade mark) Script and inhibiting operation of buttons until a response is returned from a server after single depression of the transmission button

Moreover, the other conventional method has also been proposed, in which a certain value designated with a server is embedded within a hidden tag at the time of displaying the information transmitting image, such content is sent at the time of transmission of data, and a plurality of enquiries from the same display image are blocked in the server side.

FIG. 1 is a sequence diagram in the other conventional art.

A user sends a request of registered display image from a browser of a personal computer thereof (step 101).

An application server returns the registered display image to the personal computer. Each registered display image includes an identifier to provide a unique value for every request (step 102).

A user registers the predetermined information for registration on the registered display image in the personal computer and then transmits a query including the identifier and data for registration to the application server (step 103).

A user registers again the predetermined registration information on the registration display image in the personal computer and thereafter the browser executes the multiplex transmission of the query including the identifier and registration data to the server (step 104).

The server performs the multiplex transmission check and transmits the information display image data but the information display image data is not displayed because the browser waits for a response to the subsequent multiplex transmission (steps 105, 106).

In place of such transmission of information display image data, an error display image data suggesting the multiplex transmission is displayed during this multiplex transmission check (steps 107, 108).

Otherwise, during the multiplex transmission check, the information display image data to be responded is read again from the DB (Data Base) server and is then transmitted to the browser (steps 109, 110).

However, the conventional art includes the following problems.

When the multiplex transmission is executed using a transmitting flag in the client side, a problem rises here, in which security is remarkably lower because use of the Java (registered trademark) Script can be assembled easily.

When the Java Applet, Flash are used in place of the Java Script, a problem also rises, in which more number of processing steps are required, in comparison with the THML (Hyper Text Makeup Language) for creation of Java Applet and Flash.

Moreover, in the method for blocking, in the server side, the multiplex transmission from the client side, the multiplex transmission can be determined using the hidden tag added to the data, but success or not of check, registration of data, and work in the server cannot be detected because the correct contents of the first work is not returned.

In addition, when registration of data through the identical logic is inhibited, a problem also rises, in which the intrinsic numbers such as a customer number and a transaction number which are generated for the repeated registration of data cannot be obtained.

### SUMMARY OF THE INVENTION

In view of solving the problems described above, an object of the present invention is to return the display image data or the like to a client without giving a forcible load like the first transmission process of the display image data to a server when the display image data is transmitted by the multiplex transmission from the server.

The information electronic apparatus of the present invention receives a first request information from the other information electronic apparatuses connected to networks and responds to the first request information, and is characterized by comprising a request information storing unit for storing the first request information, a response information generating unit for generating the response information to the first request information, a response information storing unit for storing the generated response information, a request information comparing unit for comparing, when a second request information is received, the first request information stored in the request information storing unit with the second request information, and a response information transmitting unit for calling, when the first request information and the second request information compared are determined to be the identical information, the response information from the response information storing unit and then transmitting this response information to the other information electronic apparatuses.

Moreover, the information electronic apparatus of the present invention is characterized in that the response information generating unit stores, when the request information is received again during generation of the response information, the information suggesting that the same request information is being stored into the response information storing unit.

The information electronic apparatus of the present invention is characterized in that the response information generating unit generates the response information and the response information storing unit records the response information and the generation end information suggesting that generation of the response information has been completed.

The response program of the present invention receives a first request information from an information electronic apparatus and sends a response to the first request information, and thus characterized in controlling a computer to execute the steps of recording the response information to record a first request information received, generating the response information to generate the response information to the first request information, recording the response information to record the response information, comparing the request information pieces, when a second request information is received, in order to compare the recorded first request information and the second request information, and transmitting the response information for calling the recorded response information and transmitting the called response information to an information electronic apparatus when the first request information and the second request information compared are identical.

The response method of the present invention receives a first request information from an information electronic apparatus and sends a response to the first request information, and characterized in comprising the steps of recording the request information to record the received first request information, generating the response information for generating the response information to the first request information, recording the response information for recording the response information, comparing the request information for comparing, when a second request information is received, the recorded first request information and the second request information, and transmitting the response information calling the response information and transmitting the same response information to the information electronic apparatus when the first request information and the second request information compared are identical.

According to a profile of the present invention, flexibility in web application of user can be improved because the result of the first transmission is surely be outputted when the multiplex transmission is performed due to an erroneous manipulation of user.

Moreover, according to another profile of the present invention, since the HTML recorded in the history is returned to user and a response is also issued, repeated generation of HTML is no longer required and thereby load of server can be alleviated.

In one embodiment of the present invention, an information electronic apparatus for receiving a first request information from another information electronic apparatus connected to a network and for sending a response to the first request information, comprises a first storing unit operable to store the first request information, a generating unit operable to generate response information to the first request information, a second storing unit operable to store the generated response information, a comparing unit operable to compare the first request information stored in the first storing unit and a second request information, when the second request information is received, and a transmitting unit operable to retrieve the response information from the second storing unit and transmit the response information to the other information electronic apparatus when the comparing unit determines that the first request information and the second request information match.

In one aspect of the present invention, the generating unit stores information indicating execution of a process to the second storing unit when the request information is received again during generation of the response information. The generating unit is further operable to generate information indicating an end of generation of the response information after the generating unit generates the response information and the second storing unit stores the response information. The comparing unit compares identifiers of the request information. The comparing unit compares hidden tags of the request information. The response information comprises HTML.

In one embodiment of the present invention, a response program for sending a response to a received first request information from an information electronic apparatus, the response program comprising program instructions executable by a computer for controlling the computer to execute the steps of storing the received first request information, generating response information responsive to the first request information, storing the response information, comparing the first request information with a second request information, in response to receiving the second request information, and transmitting the response information to the information electronic apparatus when the first request information and the second request information match.

In one aspect of the present invention, the response program further comprises the step of storing information indicating execution of a process when the request information is received again during generation of the response information. The response program further comprises the step of generating information indicating an end of generation of the response information after the steps of generating response information responsive to the first request information and storing the response information. The response program further comprises the step of comparing identifiers of the request information. In one aspect of the present invention, the response program further comprises the step of comparing hidden tags of the request information. The response information comprises HTML.

In one embodiment of the present invention, a computer program product for receiving a first request information from an information electronic apparatus and for sending a response to the first request information, comprises a computer readable medium and computer program instructions, recorded on the computer readable medium, executable by a processor, for performing the steps of storing the received first request information, generating response information responsive to the first request information, storing the response information, comparing the first request information with a second request information, in response to receiving the second request information, and transmitting the response information to the information electronic apparatus when the first request information and the second request information match.

In one aspect of the present invention, the computer program product further comprises the step of storing information indicating execution of a process when the request information is received again during generation of the response information. The computer program product further comprises the step of generating information indicating an end of generation of the response information after the steps of generating response information responsive to the first request information and storing the response information. The computer program product further comprises the step of comparing identifiers of the request information. The computer program product further comprises the step of comparing hidden tags of the request information. The response information comprises HTML.

In one embodiment of the present invention, a response method for receiving a first request information from an information electronic apparatus and sending a response to the first request information, comprises the steps of storing the received first request information, generating response information responsive to the first request information, storing the response information, comparing the first request information with a second request information, in response to receiving the second request information, and transmitting the response information to the information electronic apparatus when the first request information and the second request information match.

In one aspect of the present invention, the response method further comprises the step of storing information indicating execution of a process when the request information is received again during generation of the response information. The response method further comprises the step of generating information indicating an end of generation of the response information after the steps of generating response information responsive to the first request information and storing the response information. The response method further comprises the step of comparing identifiers of the request information. The response method further comprises the step of comparing hidden tags of the request information. The response information comprises HTML.

### BRIEF DESCRIPTION OF THE DRAWINGS

FIG. 1 is a sequence diagram of the conventional art.

FIG. 2 is a schematic diagram of the present invention.

FIG. 3 is a block diagram of the application server of the present invention.

FIG. 4 is a sequence diagram of the multiplex transmission avoiding process in the present invention.

FIG. 5 is a sequence diagram of the multiplex transmission avoiding process in the present invention.

FIG. 6 is a flowchart of the multiplex transmission in the present invention.

FIG. 7 is a diagram indicating the registered display image in the present invention and the HTML indicating the registered display image.

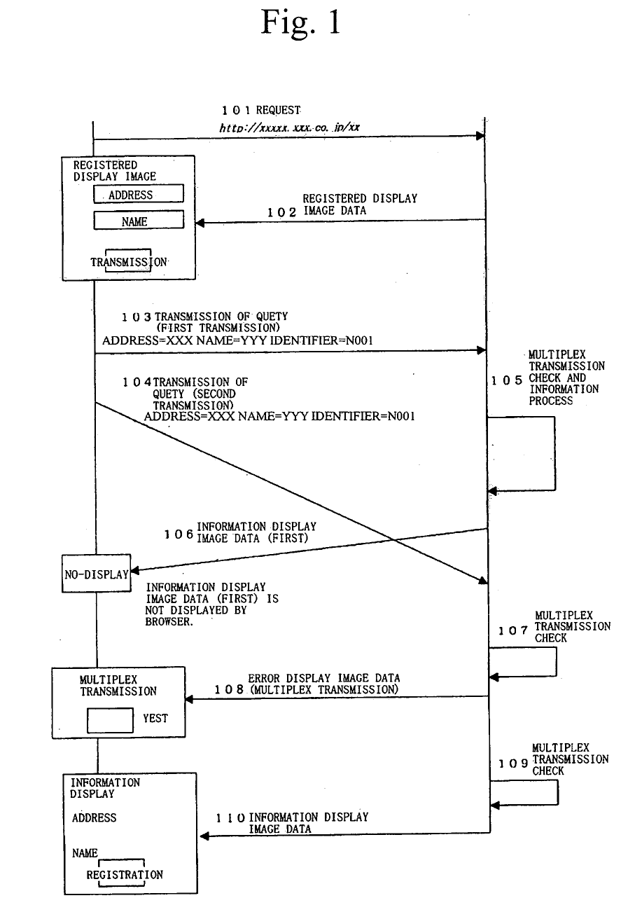

### PREFERRED EMBODIMENTS OF THE INVENTION

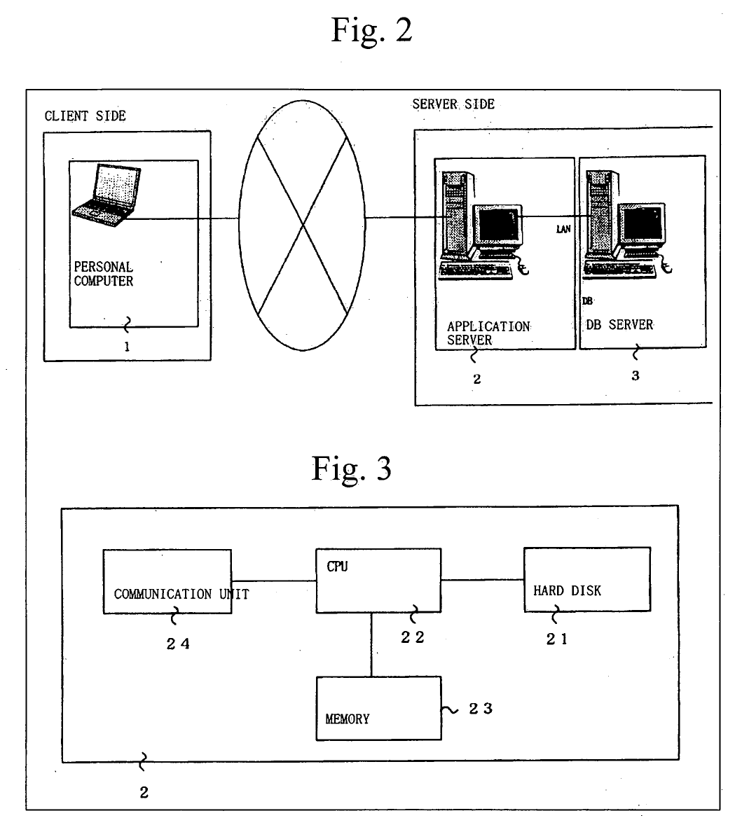

FIG. 2 is a schematic diagram of the present invention.

In FIG. 2, numeral 1 designates a personal computer manipulated by a user; 2, an application server provided with the function as the web server; 3, a DB server.

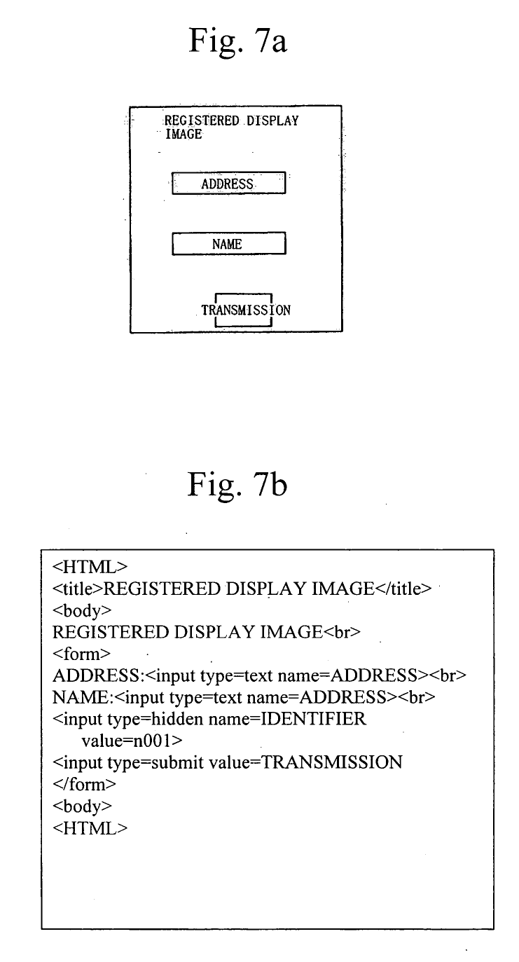

A user manipulates the personal computer 1 and sends a request for registered display image to the application server 2. Here, the registered display image has an identifier which shows a unique value for each every request. An example of the registered display image is illustrated in FIGS. 7A and 7B. FIG. 7A is the registered display image displayed, while FIG. 7B is the HTML indicating the registered display image in which the identifier is described.

The application server 2 transmits the registered display image to the personal computer 1 of a user.

A user transmits, after having registered the predetermined information for registration on the registered display image, the query including the identifier and the information for registration to the application server 2.

The application server 2 generates the information display image data for the query from the information for registration included in the query and registers the information display image data to the DB server 3.

The information display image data for the query is registered to the history of application server 2 and the end of information display image data generating process for the query is registered to the history.

When a user transmits again the query to the application server 2 while transmission of the display image information for registration to the application server 2 from the personal computer 1 is not yet completed, multiplex transmission is generated.

When the application server 2 receives the second query, the information display image data registered to the history is transmitted to the personal computer 1.

FIG. 3 is a block diagram of the application server of the present invention.

Reference numeral 21 designates a hard disk; 22, a central processing unit CPU; 23, a memory; 24, a communication unit.

Upon reception of the request for registered display image issued from the personal computer 1 through the communication unit 24, the application server 2 calls the corresponding registered display image from the hard disk 21 using with the central processing unit 22 and then transmits the registered display image to the personal computer 1 through the communication unit 24.

Here, the application server 2 receives the query including the information for registration inputted by a user from the personal computer 1 through the communication unit 21.

The application server 2 generates the information display image data for the query from the information for registration with the central processing unit 22 and transmits and registers this data to the DB server 3.

The end of information display image data generating process for the information display image data and query is registered to the history of the hard disk 21.

If the application server 2 receives again the query through the communication unit 24 while transmission of the display image information for registration to the application server 2 from the personal computer 1 is not yet completed, multiplex transmission is generated.

When the application server 2 receives the second query through the communication unit 24, the information display image data registered to the history of the hard disk 21 is transmitted to the personal computer 1 through the communication unit 24.

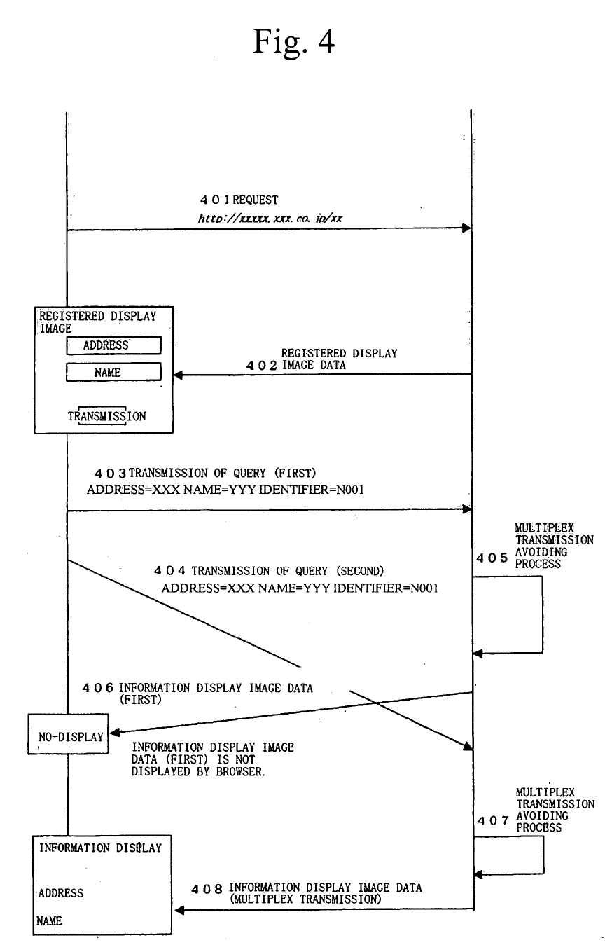

FIG. 4 is a sequence diagram of the multiplex transmission avoiding process in the present invention.

In the first embodiment, the application server 2 completes the first process before reception of the second query.

The request for registered display image is sent to the application server 2 upon reception of the query from the browser of personal computer 1 (step 401).

The application server 2 returns the registered display image to the personal computer 1 (step 402).

After registration of the predetermined information for registration on the registered display image, a user depresses the transmission button to transmit the query including the identifier and information for registration to the application server 2 (step 403).

Before completion of the transmission of the display image information for registration to the application server 2 from the personal computer 1, a user depresses again the transmission button on the registered display image to transmit the query to the application server 2 (multiplex transmission) (step 404).

The application server performs the multiplex transmission avoiding process. The application server 2 generates the information display image data for the query from the information for registration included in the query and resisters this data to the DB server 3.

The information display image data for the query is registered to the history of the application server 2 and the end of a series of jobs for the query is registered to the history (step 405).

Here, the application server 2 transmits the information display image data for the first query. However, since the browser of personal computer 1 is waiting for the information display image data for the second query, the information display image data for the first query is not displayed (step 406).

The application server 2 designates the information display image data which has been registered to the history as the second information display image data with the multiplex transmission avoiding process (step 407).

The application server 2 transmits the information display image data to the personal computer 1 (step 408).

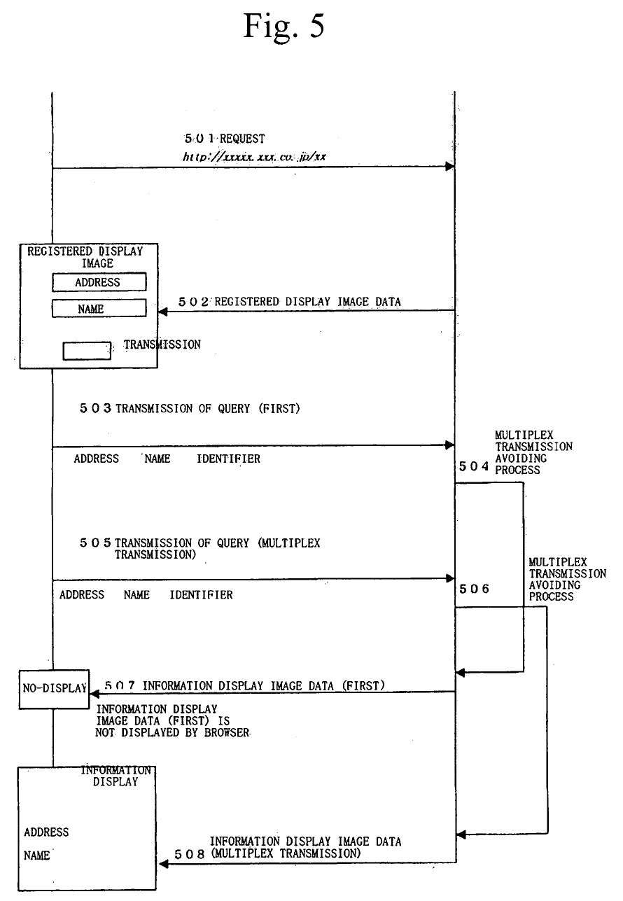

FIG. 5 is a sequence diagram of the multiplex transmission avoiding process in the present invention.

In the second embodiment, the first process is not yet completed before reception of the second query.

The request for registered display image is sent to the application server 2 upon reception of the query from the browser of personal computer 1 (step 501).

The application server 2 returns the registered display image to the personal computer 1 (step 502).

After registration of the predetermined information for registration on the registered display image, a user depresses the transmission button to transmit the query including the identifier and the information for registration to the application server 2 (step 503).

The application server 2 performs the multiplex transmission avoiding process. The application server 2 generates the information display image data for the query from the information for registration included in the query and registers this data to the DB sever 3.

The information display image data for the query is registered to the history of the application server 2 and the completion of the information display image data generating process for the query is registered to the history (step 504).

Before completion of generation of the information display image data for the query in the application server 2, a user depresses again the transmission button in the registered display image to transmit the query to the application server 2 (step 505).

In the multiplex transmission avoiding process, after generation of the information display image data for the first query is completed, the apparatus is in the waiting condition until the information display image data is registered to the history (step 506).

Here, the application server 2 transmits the information display image data for the first query. However, since the browser of the personal computer 1 is waiting for the information display image data for the second query, the information display image data for the first query is not displayed (step 507).

The application server 2 designates the information display image data registered to the history as the second information display image data with the multiplex transmission avoiding process and transmits the information display image data to the personal computer 1 (step 508).

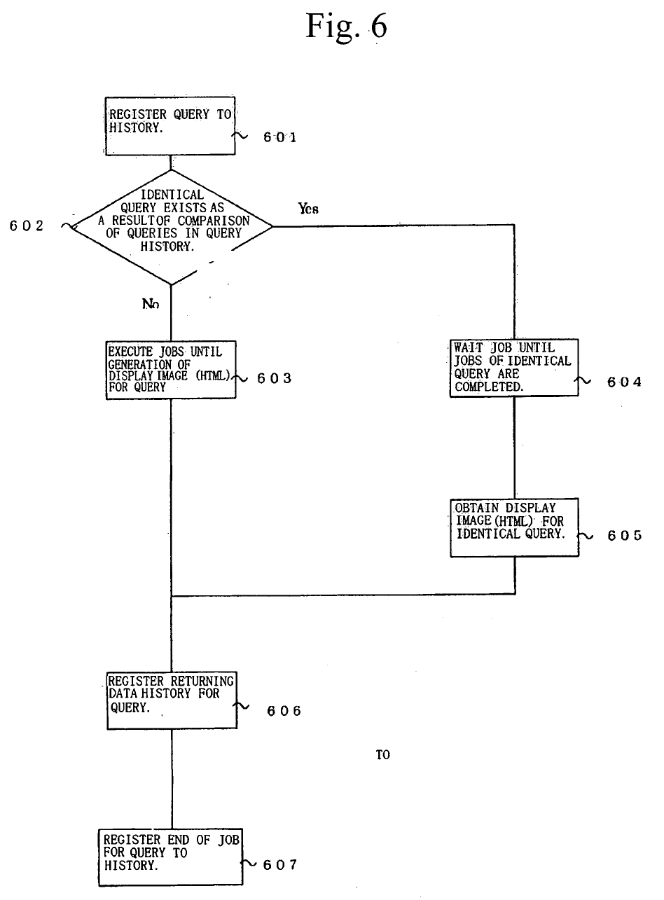

FIG. 6 is a flowchart of the multiplex transmission avoiding process of the application server 2 in the present invention.

The query transmitted from the personal computer 1 is registered to the history (step 601).

Whether the identical query exists or not is determined through comparison with the queries registered in the history (step 602).

The information display image data for the query is generated (step 603).

The apparatus is in the waiting condition until generation of the information display image data for the identical query is completed (step 604).

The information display image data for the identical query is obtained (step 605).

The information display image data for the query is registered to the history (step 606).

The end of the jobs for the query is registered to the history (step 607).

Next, modification examples of the embodiments and the other expanding items of the information electronic apparatus of the present invention described above will be described below sequentially.

In above embodiments, the application server and DB server are provided in different servers but the present invention is not limited thereto. Namely, the application server and DB server can also be provided on the same server.

In above embodiments, the information display image data is returned as the response for the query, but the present invention is not limited thereto. Namely, the other data can be used as the response.

In above embodiments, a hidden tag is used for comparing the query and the information display image data for the query. However, the query and the information display image data for the query can also be compared using the other data in addition to the hidden tag. Moreover, query and the information display image data for the query can also be compared through combination of the hidden tag and the other data.

In above embodiments, the information display image data for the query is registered to the history in the application server, but the present invention is not limited to the history.

In above embodiments, the information display image data is generated with the HTML but the present invention is not limited thereto.

In above embodiments, the end of generation of the information display image data is registered to the history, but the present invention is not limited thereto.

What is claimed is:

1. An information electronic apparatus for receiving a first request information from another information electronic apparatus connected to a network and for sending a response to the first request information, comprising:
a first storing unit operable to store the first request information;
a generating unit operable to generate response information to the first request information;
a second storing unit operable to store the generated response information;
a comparing unit operable to compare the first request information stored in the first storing unit and a second request information, when the second request information is received; and
a transmitting unit operable to retrieve the response information from the second storing unit and transmit the response information to the other information electronic apparatus when the comparing unit determines that the first request information and the second request information match.

2. The information electronic apparatus of claim 1, wherein the generating unit stores information indicating execution of a process to the second storing unit when the request information is received again during generation of the response information.

3. The information electronic apparatus of claim 1, wherein the generating unit is further operable to generate information indicating an end of generation of the response information after the generating unit generates the response information

4. The information electronic apparatus of claim 1, wherein the comparing unit compares identifiers of the request information.

5. The information electronic apparatus of claim 1, wherein the comparing unit compares hidden tags of the request information.

6. The information electronic apparatus of claim 1, wherein the response information comprises HTML.

7. A response program for sending a response to a received first request information from an information electronic apparatus, the response program comprising program instructions executable by a computer for controlling the computer to execute the steps of:
storing the received first request information;
generating response information responsive to the first request information;
storing the response information;
comparing the first request information with a second request information, in response to receiving the second request information; and
transmitting the response information to the information electronic apparatus the first request information and the second request information match.

8. The response program of claim 7, further comprising the step of:
storing information indicating execution of a process when the request information is received again during generation of the response information.

9. The response program of claim 7, further comprising the step of:
generating information indicating an end of generation of the response information after the steps of generating response information responsive to the first request information.

10. The response program of claim 7, further comprising the step of:
comparing identifiers of the request information.

11. The response program of claim 7, further comprising the step of:
comparing hidden tags of the request information.

12. The response program of claim 7, wherein the response information comprises HTML.

13. A computer program product for receiving a first request information from an information electronic apparatus and for sending a response to the first request information, comprising:
a computer readable medium;
computer program instructions, recorded on the computer readable medium, executable by a processor, for performing the steps of
storing the received first request information;
generating response information responsive to the first request information;
storing the response information;
comparing the first request information with a second request information, in response to receiving the second request information; and
transmitting the response information to the information electronic apparatus when the first request information and the second request information match.

14. The computer program product of claim 13, further comprising the step of:
storing information indicating execution of a process when the request information is received again during generation of the response information.

15. The computer program product of claim 13, further comprising the step of:
generating information indicating an end of generation of the response information after the steps of generating response information responsive to the first request information.

16. The computer program product of claim 13, further comprising the step of:
comparing identifiers of the request information.

17. The computer program product of claim 13, further comprising the step of:
comparing hidden tags of the request information.

18. The computer program product of claim 13, wherein the response information comprises HTML.

19. A response method for receiving a first request information from an information electronic apparatus and sending a response to the first request information, comprising the steps of:
storing the received first request information;
generating response information responsive to the first request information;
storing the response information;
comparing the first request information with a second request information, in response to receiving the second request information; and
transmitting the response information to the information electronic apparatus when the first request information and the second request information match.

20. The response method of claim 19, further comprising the step of:
storing information indicating execution of a process when the request information is received again during generation of the response information.

21. The response method of claim 19, further comprising the step of:
generating information indicating an end of generation of the response information after the steps of generating response information responsive to the first request information.

22. The response method of claim 19, further comprising the step of:
comparing identifiers of the request information.

23. The response method of claim 19, further comprising the step of:
comparing hidden tags of the request information.

24. The response method of claim 19, wherein the response information comprises HTML.
